(19) United States
(12) Patent Application Publication
(10) Pub. No.: US 2011/0246870 A1
(43) Pub. Date: Oct. 6, 2011

(54) VALIDATING MARKUP LANGUAGE SCHEMAS AND SEMANTIC CONSTRAINTS

(75) Inventors: Shiguang Dong, Beijing (CN); Haiyang Gao, Beijing (CN); Jun Zhang, Beijing (CN); Dong-Hui Zhang, Beijing (CN)

(73) Assignee: Microsoft Corporation, Redmond, WA (US)

(21) Appl. No.: 12/753,189

(22) Filed: Apr. 2, 2010

(51) Int. Cl. G06F 17/00; G06F 11/07

(52) U.S. Cl. 715/237; 714/48; 714/E11.025

(57) ABSTRACT

Semantic constraints and schemas may be validated in markup language documents. A computer may be utilized to receive a strongly-typed document object model representing a markup language document. The computer may then be utilized to load semantic constraints and validate the strongly-typed document object model representing the markup language document to determine whether the semantic constraints have been met. Then, the computer may be utilized to generate a result based on the validation. The computer may also be utilized to load schema constraints for a schema used to define a markup language document and validate a strongly-typed document object model representing the markup language document against the schema constraints. Then, the computer may be utilized to generate a result based on the validation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

File formats have been developed to represent electronic documents generated by proprietary software platforms such as office productivity applications. The use of these file formats allow electronic office documents such as word processing documents, spreadsheet documents, presentation documents, and drawing documents, to be shared across multiple platforms and for viewing in a Web browser. One current file format, which utilizes extensible markup language (“XML”) for representing electronic office documents, is “Open XML” developed by MICROSOFT CORPORATION of Redmond, Wash. The Open XML format defines a set of XML markup vocabularies for office electronic documents as well as mathematical formulae, graphics, bibliographies, etc., which are utilized within these documents. Currently however, there is no known way to validate whole Open XML documents against Open XML file formats in order to identify schema or semantic data errors. Current validation methods which are limited to validating Open XML parts, fail to report meaningful errors based on file formats. Furthermore, these current validation methods fail to validate Open XML content at the semantic level. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for validating semantic constraints in a markup language document. A computer may be utilized to receive a strongly-typed document object model representing a markup language document. The computer may then be utilized to load semantic constraints and validate the strongly-typed document object model representing the markup language document to determine whether the semantic constraints have been met. Then, the computer may be utilized to generate a result based on the validation.

Embodiments are also provided for validating a markup language document against a schema. A computer may be utilized to receive a strongly-typed document object model representing the markup language document. The computer may then be utilized to load schema constraints for a schema used to define the markup language document and validate the strongly-typed document object model representing the markup language document against the schema constraints. Then, the computer may be utilized to generate a result based on the validation.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating various software components which may be utilized in validating semantic constraints in a markup language document, in accordance with various embodiments;

FIG. 2 is a block diagram illustrating various software components which may be utilized in validating a markup language document against a schema, in accordance with various embodiments;

FIG. 3 is a block diagram illustrating a computer which may be utilized for validating semantic constraints in a markup language document and validating a markup language document against a schema, in accordance with various embodiments;

FIG. 4 is a flow diagram illustrating a routine for validating semantic constraints in a markup language document, in accordance with various embodiments; and

FIG. 5 is a flow diagram illustrating a routine for validating a markup language document against a schema, in accordance with various embodiments.

### DETAILED DESCRIPTION

Embodiments are provided for validating semantic constraints in a markup language document. A computer may be utilized to receive a strongly-typed document object model representing a markup language document. The computer may then be utilized to receive semantic constraints and validate the strongly-typed document object model representing the markup language document to determine whether the semantic constraints have been met. Then, the computer may be utilized to generate a result based on the validation.

Embodiments are also provided for validating a markup language document against a schema. A computer may be utilized to receive a strongly-typed document object model representing the markup language document. The computer may then be utilized to load schema constraints for a schema used to define the markup language document and validate the strongly-typed document object model representing the markup language document against the schema constraints. Then, the computer may be utilized to generate a result based on the validation.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents. Referring now to the drawings, in which like numerals represent like elements through the several figures, various aspects of the present invention will be described.

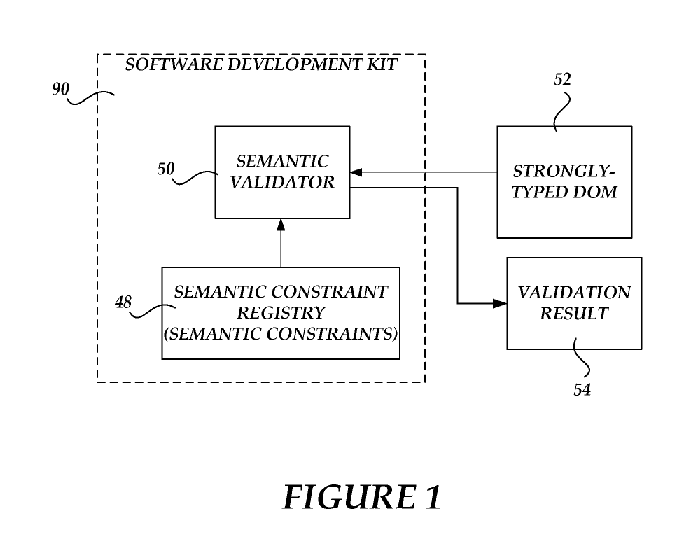

FIG. 1 is a block diagram illustrating various software components which may be utilized in validating semantic constraints in a markup language document, in accordance with various embodiments. In accordance with an embodiment, the software components may be incorporated in a software development kit 90 which may comprise a dynamic link library (“DLL”). The software development kit 90 may include a semantic constraint registry 48 and a semantic validator 50.

The semantic constraint registry 48 may comprise computer program code representing semantic constraints for a markup language document. In accordance with an embodiment, the markup language document may comprise a document which has been formatted according to the Open XML file format developed by MICROSOFT CORPORATION of Redmond, Wash. Open XML documents may include word processing documents, spreadsheet documents, and presentation documents which are generated by generated by the OFFICE suite of productivity software programs marketed by MICROSOFT CORPORATION of Redmond, Wash. In accordance with an embodiment, the semantic constraints may comprise constraints for use in a markup language document comprising markup language elements and attributes as well as markup language parts. The semantic constraints may be defined by natural English language expressions. It should be appreciated that the semantic constraints may not be represented by an XML schema because they are not limited to a single XML element or attribute. For example, a semantic constraint may require that two markup language elements depend upon one another. Thus, if a first markup language element exists in an Open XML document then a second markup language element must also exist in the same document, otherwise a validation of the document would generate an error. In accordance with an embodiment, the semantic constraints, after being defined by natural English language expressions, may be translated into “Schematron” expressions before being stored in the semantic constraint registry 48. As should be understood by those skilled in the art, Schematron is a rule-based validation language for making assertions about the presence or absence of patterns in XML trees. Thus, the Schematron language may be utilized for representing the semantic constraints to validate XML documents. The semantic constraint registry 48 may be generated by a code generator which comprises a partial Schematron parser (not shown) to generate the semantic constraint registry 50 from semantic data i.e., Schematron files).

The semantic validator 50 may comprise an application programming interface (“API”) which is utilized to compare the semantic constraint registry 48 with a strongly-typed document object model (“DOM”) 52 (representing a markup language document) in order to validate the markup language document against the constraints. As should be understood by those skilled in the art, “strongly-typed” DOMs include defined classes for markup language elements. Thus, the contents of markup language parts are accessed via the defined classes. The semantic validator 50 may also be configured to generate a validation result 54 (e.g., an error message) as a result of the comparison. In accordance with various embodiments, the semantic validator 50 will report errors on the classes/objects instead of nodes (e.g., XML nodes). Those skilled in the art should appreciate that more meaningful error messages are generated when the errors are based on object errors rather than XML node errors.

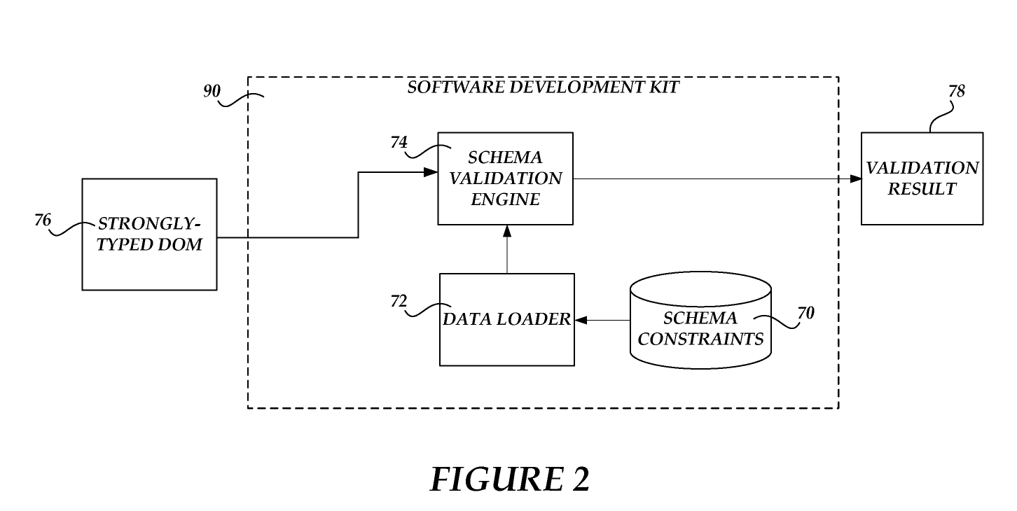

FIG. 2 is a block diagram illustrating various software components which may be utilized in validating a markup language document against a schema, in accordance with various embodiments. In accordance with an embodiment, the software components may be incorporated in the software development kit 90. The software components may include schema constraints 70, a data loader 72, and a schema validation engine 74.

In accordance with various embodiments, the schema constraints 70 may define markup language element types that are allowed to be children of another element. Other schema constraints may include limiting a markup language attribute to only a predetermined set of values or limiting a markup language element to a predetermined number of child elements of a certain type. In accordance with an embodiment, schema constraints 70 may be generated by a code generator, a schema processor, and a data builder. The code generator may comprise a software component which is utilized to generate a class-to-schema type map from the one or more schemas. In particular, the code generator may be utilized to map constraints defined for the markup language elements in the schemas to objects thereby generating constraints in the schema constraints 70. For example, the schemas may define a constraint that a paragraph element may only generate a single paragraph. The code generator may generate schema constraint data for this constraint and map the constraint to a paragraph object. The schema processor may comprise a software component which is utilized to dump (i.e., convert) schemas into binary data. The data builder may comprise a software component which is utilized to compress the binary data from the schema processor and the class-to-schema type map to generate a database for the schema constraints 70. The compression also enables the data loader 72 to read the schema constraints 70.

The data loader 72 may be utilized to load the schema constraints 70 as computer program code for access by the schema validation engine 74. The schema validation engine 74 may be utilized to validate the schema constraints 70 (received via the data loader 72) against schema constraints in a markup language document by comparing the schema constraints 70 to a strongly typed markup language document DOM 76 (which is representative of a markup language document). The semantic validator 50 may also be configured to generate a validation result 78 (e.g., an error message) as a result of the comparison.

### Exemplary Operating Environment

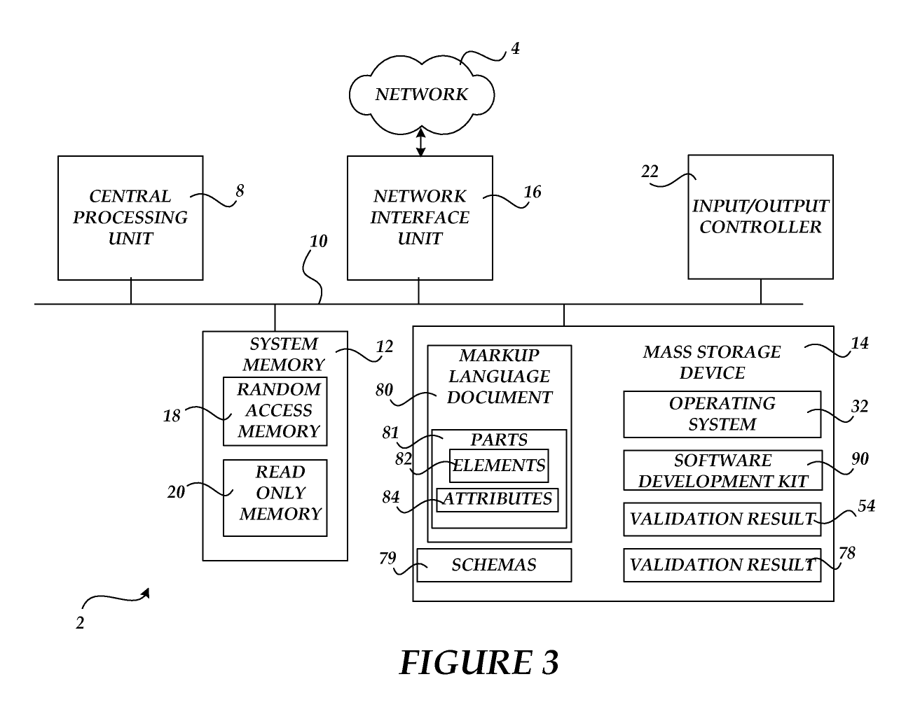

Referring now to FIG. 3, the following discussion is intended to provide a brief, general description of a suitable computing environment in which various illustrative embodiments may be implemented. While various embodiments will be described in the general context of program modules that execute in conjunction with program modules that run on an operating system on a computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 3 shows a computer 2 which may comprise any type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The computer 2 may further include a mass storage device 14 for storing an operating system 32, a markup language document 80 (which comprises parts 81, elements 82 and attributes 84), the validation result 54, the validation result 78, schemas 79, and the software development kit 90. In accordance with an embodiment, the schemas 79 may comprise standard and specific open markup language schemas. For example, the schemas 79 may include, without limitation, Open XML standard schemas as well as specific schemas utilized with word processing, spreadsheet, and presentation applications comprising the OFFICE suite of productivity software programs developed by MICROSOFT CORPORATION of Redmond, Wash.

In accordance with various embodiments, the operating system 32 may be suitable for controlling the operation of a networked computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the computer 2. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as a computer program product.

According to various embodiments, the computer 2 may operate in a networked environment using logical connections to remote computers through a network 4 which may comprise, for example, a local network or a wide area network (e.g., the Internet). The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display device, a printer, or other type of output device. Additionally, a touch screen can serve as an input and an output mechanism.

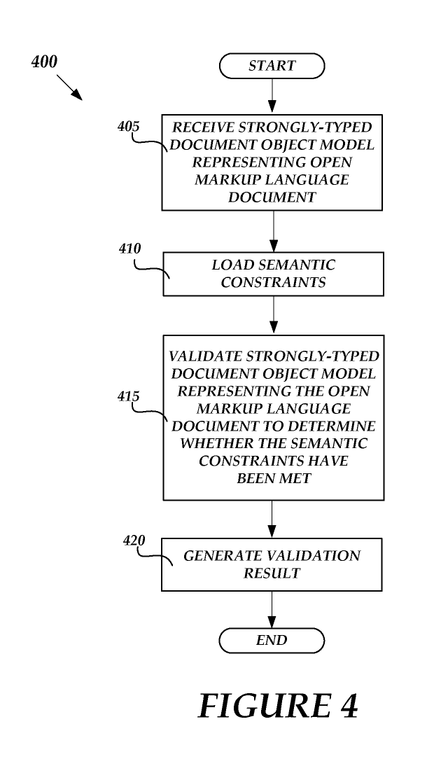

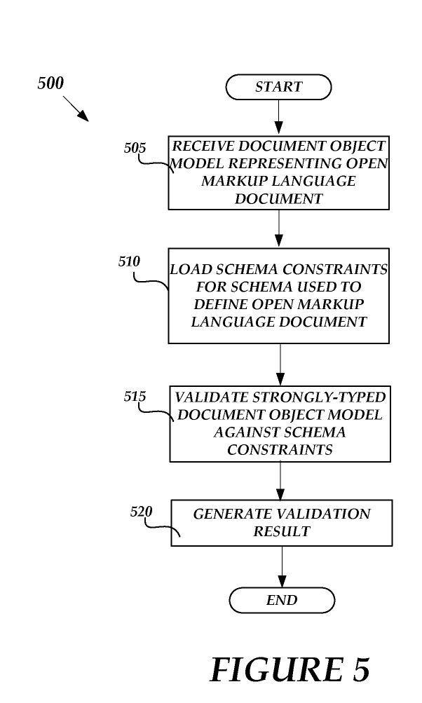

FIG. 4 is a flow diagram illustrating a routine 400 for validating semantic constraints in a markup language document, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 4-5 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 400 begins at operation 405, where the computer 2 (utilizing instructions in the software development kit 90), receives the strongly-typed DOM 52 representing the open markup language document 80. In particular, the computer 2 may receive a strongly-typed DOM representative of the markup language parts 81, elements 82, and attributes 84 in the markup language document 80. It should be understood that the strongly-typed DOM 52 (as well as the strongly-typed DOM 76) may include objects loaded into the system memory 12 of the computer 2 by the software development kit 90 from the markup language document 80. For example, if the markup language document 80 represents an Open XML word processing document, all paragraph, table, row, and other elements in the XML content of the document are loaded as Paragraph, Table, Row, and other objects. The loaded Paragraph, Table, Row, and other objects are strongly-typed objects.

From operation 405 the routine 400 continues to operation 410, where the computer 2 loads semantic constraints from the semantic constraint registry 48. In particular, the computer 2 may load one or more expressions from the semantic constraint registry 48, such as an expression that requires a first markup language element 82 in the markup language document 80 to depend upon a second markup language element 82 in the markup language document 80.

From operation 410, the routine 400 continues to operation 415, where computer 2 utilizes the semantic validator 50 to validate the strongly-typed DOM 52 (representing the markup language document 80) to determine whether the semantic constraints have been met. In particular, in accordance with an embodiment, the semantic validator 50 may be configured to navigate the strongly-typed DOM 52 (representing the markup language document 80) to locate the markup language elements 80 and markup language attributes 84 upon which to enforce the semantic constraints and then attempt to enforce the semantic constraints. In accordance with another embodiment, the semantic validator 50 may be configured to navigate across the markup language parts 81 to locate the markup language elements 80 and markup language attributes 84 upon which to enforce the semantic constraints and then attempt to enforce the semantic constraints.

From operation 415, the routine 400 continues to operation 420, where the computer 2 may utilize the semantic validator 50 to generate the result 54 based on the validation. For example, if one of the semantic constraints is not met by the elements 82 in the markup language document 80, then the result 54 generated by the semantic validator 50 may comprise an error message. From operation 420, the routine 400 then ends.

Turning now to FIG. 5, an illustrative routine 500 for validating a markup language document against a schema will now be described, in accordance with various embodiments. The routine 500 begins at operation 505, where the computer 2 utilizes the schema validation engine 74 (in the software development kit 90) to receive the markup language document DOM 76 representing the markup language document 90. In particular, the computer 2 may receive a strongly-typed DOM representative of the markup language elements 82 and the attributes 84 in the markup language document 80.

From operation 505, the routine 500 continues to operation 510, where computer 2 may utilize the schema validation engine 74 to load the schema constraints 70 from the data loader 72.

From operation 510, the routine 500 continues to operation 515, where the computer 2 may utilize the schema validation engine 74 to validate the open markup language DOM 76 against the schema constraints 70. In particular, the schema validation engine 74 may be configured to identify open markup language content that violates a file format syntax defined in the schemas 70. The determination of a file format syntax violation may be based on a number of constraints including, without limitation, a predetermined set of values allowed for one or more markup language attributes, a predetermined number of child elements of a certain type allowed for one or more markup language elements, and predefined markup language element types allowed to be children of one or more other markup language elements.

From operation 515, the routine 500 continues to operation 520, where the computer 2 may utilize the schema validation engine 74 to generate the result 78 based on the validation. For example, if one of the elements 82 or attributes 84 in the markup language document 80 violates a file format syntax defined in the schemas 79, then the validation result 78 generated by the schema validation engine 74 may comprise an error message. From operation 520, the routine 500 then ends.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method of validating semantic constraints in a markup language document, comprising:
receiving, by the computer, a strongly-typed document object model representing the markup language document;
loading, by the computer, semantic constraints;
validating, by the computer, the strongly-typed document object model representing the markup language document to determine whether the semantic constraints have been met; and
generating, by the computer, a result based on the validation.

2. The method of claim 1, wherein receiving a strongly-typed document object model representing the markup language document comprises receiving a strongly-typed document object model representing at least one of markup language elements and markup language attributes in the markup language document.

3. The method of claim 1, wherein loading semantic constraints comprises loading at least one expression from a semantic constraint registry, wherein the at least one expression requires that a first markup language element in the markup language document depend upon a second markup language element in the markup language document.

4. The method of claim 1, wherein validating the strongly-typed document object model representing the markup language document to determine whether the semantic constraints have been met comprises navigating the strongly-typed document object model representing the markup language document to locate at least one of markup language elements and markup language attributes upon which to enforce the semantic constraints.

5. The method of claim 1, wherein validating the strongly-typed document object model representing the markup language document to determine whether the semantic constraints have been met comprises navigating across at least one markup language part utilized in the markup language document to locate at least one of markup language elements and markup language attributes upon which to enforce the semantic constraints.

6. The method of claim 1, wherein generating a result based on the validation comprises generating an error message.

7. A computer system for validating a markup language document against a schema, comprising:
a memory for storing executable program code; and
a processor, functionally coupled to the memory, the processor being responsive to computer-executable instructions contained in the program code and operative to:
receive a strongly-typed document object model representing the markup language document;
load schema constraints for a schema used to define the markup language document;
validate the strongly-typed document object model representing the markup language document against the schema constraints; and
generate a result based on the validation.

8. The system of claim 7, wherein the processor in receiving a strongly-typed document object model representing the markup language document comprises receiving a strongly-typed document object model representing markup language elements in the markup language document.

9. The system of claim 7, wherein the processor in receiving a strongly-typed document object model representing the markup language document comprises receiving a strongly-typed document object model representing markup language attributes in the markup language document.

10. The system of claim 7, wherein the processor in loading the schema constraints for a schema used to define the open markup language document, is operative to utilize a data loader to load the schema constraints from a database.

11. The system of claim 7, wherein the processor in validating the document object model representing the markup language document against the schema constraints, is operative to identify content in the markup language document that violates a file format syntax defined in at least one markup language schema.

12. The system of claim 7, wherein the processor in generating a result based on the validation, is operative to generate an error message.

13. The system of claim 11, wherein the processor in identifying content in the markup language document that violates a file format syntax defined in the at least one markup language schema, is operative to identify content which violates the file format syntax based on a predetermined set of values allowed for a markup language attribute.

14. The system of claim 11, wherein the processor in identifying content in the markup language document that violates a file format syntax defined in the at least one markup language schema, is operative to identify content which violates the file format syntax based on a predetermined number of child elements of a certain type allowed for a markup language element.

15. The system of claim 11, wherein the processor in identifying content in the markup language document that violates a file format syntax defined in the at least one markup language schema, is operative to identify content which violates the file format syntax based on predefined markup language element types allowed to be children of another markup language element.

16. A computer-readable storage medium comprising computer executable instructions which, when executed by a computer, will cause the computer to perform a method of validating semantic constraints in a markup language document, comprising:
receiving a strongly-typed document object model representing the markup language document;
loading semantic constraints from a semantic constraint registry, the semantic constraints comprising at least one expression requiring that a first markup language element in the markup language document depend upon a second markup language element in the markup language document;
validating, the strongly-typed document object model representing the markup language document to determine whether the semantic constraints have been met; and
generating a result based on the validation, the result comprising an error message.

17. The computer-readable storage medium of claim 16, wherein receiving a strongly-typed document object model representing the markup language document comprises receiving a strongly-typed document object model representing markup language elements in the markup language document.

18. The computer-readable storage medium of claim 16, wherein receiving a strongly-typed document object model representing the markup language document comprises receiving a strongly-typed document object model representing markup language attributes in the markup language document.

19. The computer-readable storage medium of claim 16, wherein validating the strongly-typed document object model representing the markup language document to determine whether the semantic constraints have been met comprises navigating the strongly-typed document object model representing the markup language document to locate at least one of markup language elements and markup language attributes upon which to enforce the semantic constraints.

20. The computer-readable storage medium of claim 16, wherein validating the strongly-typed document object model representing the markup language document to determine whether the semantic constraints have been met comprises navigating across at least one markup language part utilized in the markup language document to locate at least one of markup language elements and markup language attributes upon which to enforce the semantic constraints.
